(19) United States
(12) Patent Application Publication
(10) Pub. No.: US 2007/0223882 A1
(43) Pub. Date: Sep. 27, 2007

(54) Information processing apparatus and information processing method

(76) Inventor: Shinji Kuno, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/726,097

(22) Filed: Mar. 21, 2007

(30) Foreign Application Priority Data
Mar. 22, 2006 (JP) 2006-078222

(51) Int. Cl. H04N 7/00

(52) U.S. Cl. 386/95

(57) ABSTRACT

According to one embodiment, there is provided an information processing apparatus that includes a frame buffer to store graphics data, a control section to perform control to alternately store in a plurality of buffers data of even-numbered lines and data of odd-numbered lines in picture data based on a progressive mode and to perform control to stop and restart supply of data, thereby generating pulled-down picture data, and a field assembling processing section to execute field assembling processing of graphics data having a resolution appropriate for an image size of the frame buffer based on the picture data generated by the control section.

### CROSS-REFERENCE TO RELATED APPLICATIONS

This application is based upon and claims the benefit of priority from Japanese Patent Application No. 2006-078222, filed Mar. 22, 2006, the entire contents of which are incorporated herein by reference.

### BACKGROUND

1. Field

One embodiment of the invention relates to an information processing apparatus provided with a function of an HD DVD (high definition digital versatile disc) player and an information processing method.

2. Description of the Related Art

In recent years, with advancement of a digital compression and encoding technology for moving images, a reproduction apparatus (a player) capable of coping with high-definition pictures based on an HD (high definition) standard has been developed.

In this type of player, a function of blending a plurality of sets of image data on a higher dimensional level is demanded to improve interactivity.

For example, Jpn. Pat. Appln. KOKAI Publication No. 205092-1996 discloses a system which combines graphics data and video data by using a display controller. In this system, the display controller captures video data and combines the captured video data in an area which is a part of a graphics screen.

Meanwhile, an information processing apparatus such as a personal computer (PC) is generally configured on the assumption that an image is output in a progressive mode. In case of realizing reproduction of a picture like a movie in a PC, a picture in the progressive mode having a rate of 24 frames/second is converted into a picture in the progressive mode having a rate of 30 frames/second and the converted picture is output, for example. However, in such a method, deterioration in a quality when reproducing a picture is remarkable.

On the other hand, a commercial-off-the-shelf device such as a playback-only device, a picture in the progressive mode having a rate of 24 frames/second is generally converted into a picture in an interlace mode having a rate of 60 frames/second and the converted picture is output. In such a conversion method, reproduction is possible while substantially maintaining a quality of an original picture.

In the information processing apparatus such as a PC, enabling reproduction with a picture quality comparable to that of a commercial-off-the-shelf device is demanded.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a structure of a reproduction apparatus according to an embodiment of the invention;

FIG. 2 is an exemplary view showing a structure of a player application used in the reproduction apparatus depicted in FIG. 1;

FIG. 3 is an exemplary view explaining a functional structure of a software decoder realized by the player application depicted in FIG. 2;

FIG. 4 is an exemplary view explaining blend processing executed by a blend processing section provided in the reproduction apparatus depicted in FIG. 1;

FIG. 5 is an exemplary view explaining blend processing executed by a GPU provided in the reproduction apparatus depicted in FIG. 1;

FIG. 6 is an exemplary view showing how sub video data is superimposed on main video data and displayed in the reproduction apparatus depicted in FIG. 1;

FIG. 7 is an exemplary view showing how main video data is displayed in a partial region on sub video data in the reproduction apparatus depicted in FIG. 1;

FIG. 8 is an exemplary conceptual view showing a procedure of superimposing each of a plurality of sets of image data in AV contents based on an HD standard in the reproduction apparatus depicted in FIG. 1;

FIG. 9 is an exemplary block diagram showing constituent parts concerning control which realizes reproduction of a picture quality comparable to that of a commercial-off-the-shelf device by using a function of the GPU;

FIG. 10 is an exemplary view explaining a double buffer mode using frame buffers;

FIG. 11 is an exemplary view explaining a structure of data stored in one frame buffer;

FIG. 12 is an exemplary view explaining a method of writing data depicted in FIG. 11 as a data for an interlace mode;

FIG. 13 is an exemplary view explaining processing realized by a field composer;

FIG. 14 is an exemplary view showing an example of an internal structure of a scaling processing section depicted in FIG. 13;

FIG. 15 is an exemplary view explaining a procedure of controlling buffers by an S/W decoder depicted in FIG. 13;

FIG. 16 is an exemplary view showing how a progressive image is pulldown-converted into an interlace image by control depicted in FIG. 15; and

FIG. 17 is an exemplary view showing an example of a specific technique in scaling processing.

### DETAILED DESCRIPTION

Various embodiments according to the invention will be described hereinafter with reference to the accompanying drawings. In general, according to one embodiment of the invention, there is provided an information processing apparatus that includes a frame buffer to store graphics data, a control section to perform control to alternately store in a plurality of buffers data of even-numbered lines and data of odd-numbered lines in picture data based on a progressive mode and to perform control to stop and restart supply of data, thereby generating pulled-down picture data, and a field assembling processing section to execute field assembling processing of graphics data having a resolution appropriate for an image size of the frame buffer based on the picture data generated by the control section.

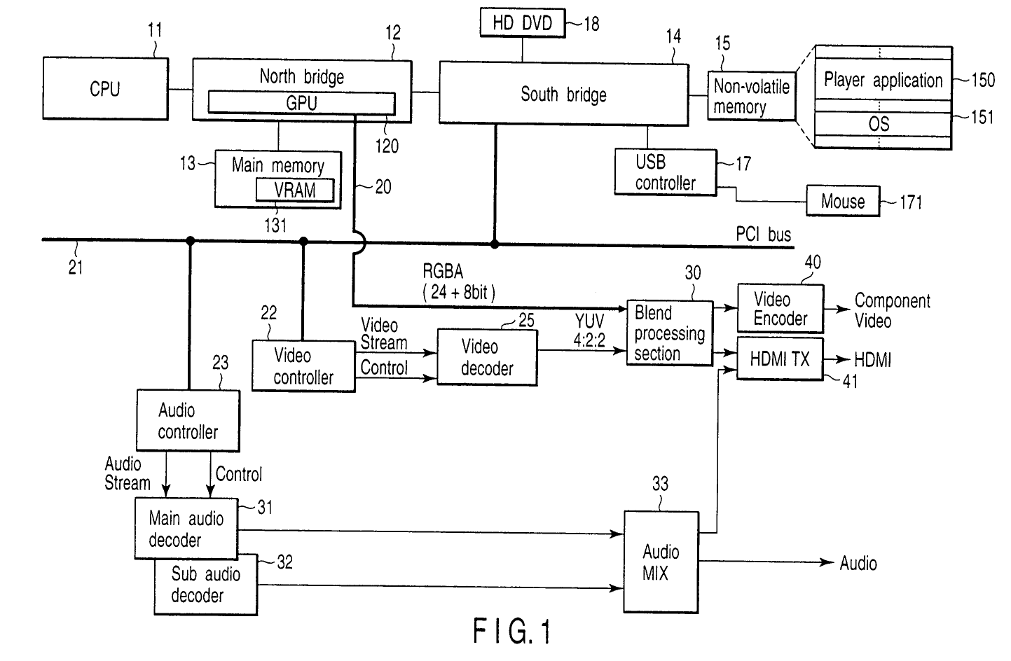

FIG. 1 shows a structural example of a reproduction apparatus according to an embodiment of the invention. This reproduction apparatus is an information processing apparatus adopting an architecture of a PC, and provided with a function as a media player which reproduces audio video (AV) contents. This reproduction apparatus is realized as an HD DVD (high definition digital versatile disc) player which reproduces audio video (AV) contents stored in a DVD medial based on, e.g., an HD DVD standard.

As shown in FIG. 1, this HD DVD player is constituted of a central processing unit (CPU) 11, a north bridge 12, a main memory 13, a south bridge 14, a non-volatile memory 15, a universal serial bus (USB) controller 17, an HD DVD drive 18, a graphics bus 20, a peripheral component interconnect (PCI) bus 21, a video controller 22, an audio controller 23, a video decoder 25, a blend processing section 30, a main audio decoder 31, a sub audio decoder 32, an audio mixer (audio mix) 33, a video encoder 40, an AV interface (HDMI-TX) 41 such as a high definition multimedia interface (HDMI), and others.

In this HD DVD player, a player application 150 and an operating system (OS) 151 are installed in the non-volatile memory 15 in advance. The player application 150 is software which operates on the OS 151, and controls for reproduction of AV contents read from the HD DVD drive 18.

AV contents stored in a storage media such as an HD DVD media driven by the HD DVD drive 18 includes compressed and encoded main video data, compressed and encoded main audio data, compressed and encoded sub video data, compressed and encoded sub-picture data, graphics data including alpha data, compressed and encoded sub audio data, navigation data which controls reproduction of the AV contents and others.

The compressed and encoded main video data is data obtained by compressing and encoding moving image data used as a main picture (a main screen image) in a compression and encoding mode based on an H.264/AVC standard. The main video data is formed of a high-definition image based on an HD standard. Further, main video data based on a standard definition (SD) standard can be also used. The compressed and encoded main audio data is audio data corresponding to the main video data. Reproduction of the main audio data is executed in synchronization with reproduction of the main video data.

The compressed and encoded sub video data is a sub-picture (a sub-screen image) displayed in a state where it is superimposed on main video, and formed of a moving image (e.g., a scene of interviewing a movie director) complementing the main video data. The compressed and encoded sub audio data is audio data corresponding to the sub video data. Reproduction of the sub audio data is executed in synchronization with reproduction of the sub video data.

The graphics data is also a sub-picture (a sub-screen image) displayed in a state where it is superimposed on main video, and formed of various kinds of data (advanced elements) required to display, e.g., an operation guidance like a menu object. Each Advanced Element is constituted of a still image, a moving image (including an animation) or a text. The player application 150 has a drawing function which makes a drawing in accordance with a mouse operation by a user. An image drawn by this drawing function is also used as graphics data, and can be displayed in a state where it is superimposed on main video.

The compressed and encoded sub-picture data includes a text such as a subtitle.

The navigation data includes a playlist which controls a reproduction order of contents and a script which controls reproduction of sub video, graphics (advanced elements) and others. The script is written in a markup language such as XML.

The main video data based on the HD standard has a resolution of, e.g., 1920×1080 pixels or 1280×720 pixels. Moreover, each of the sub video data, the sub-picture data and the graphics data has a resolution of, e.g., 720×480 pixels.

In this HD DVD player, separation processing of separating the main video data, the main audio data, the sub video data, the sub audio data and the sub-picture data from an HD DVD stream read from the HD DVD drive 18 and decoding processing of decoding the sub video data, the sub-picture data and the graphics data are executed by software (the player application 150). On the other hand, processing requiring a large throughput, i.e., processing of decoding the main video data, decoding processing of decoding the main audio data and the sub audio data and others are executed by hardware.

The CPU 11 is a processor provided to control an operation of this HD DVD player, and executes the OS 151 and the player application 150 which are loaded to the main memory 13 from the non-volatile memory 15. A part of a storage region in the main memory 13 is used as a video memory (VRAM) 131. It is to be noted that a part of the storage region in the main memory 13 does not have to be necessarily used as the VRAM 131, and a dedicated memory device which is independent from the main memory 13 may be utilized as the VRAM 131.

The north bridge 12 is a bridge device which connects a local bus of the CPU 11 with the south bridge 14. A memory controller which controls access of the main memory 13 is included in this north bridge 12. Additionally, a graphics processing unit (GPU) 120 is also included in this north bridge 12.

The GPU 120 is a graphics controller which generates a graphics signal forming a graphics screen image from data written in the video memory (the VRAM) 131 allocated to a part of the storage region of the main memory 13 by the CPU 11. The GPU 120 uses a graphics arithmetic function such as bit block transfer to generate a graphics signal. For example, when image data (sub video, sub-picture, graphics and cursor) is written in each of four planes in the VRAM 131 by the CPU 11, the GPU 120 executes blend processing of superimposing the image data corresponding to these four planes for each pixel by using bit block transfer, and thereby generates a graphics signal required to form a graphics screen image having the same resolution (e.g., 1920×1080 pixels) as that of main video. The blend processing is executed by using alpha data corresponding to each of sub video, sub-picture and graphics. The alpha data is a coefficient indicative of clarity (or opacity) of each pixel of image data corresponding to the alpha data. The alpha data corresponding to each of sub video, sub-picture and graphics is stored in the HD DVD media together with image data of sub video, sub-picture and graphics. That is, each of sub video, sub-picture and graphics is formed of the image data and the alpha data.

A graphics signal generated by the GPU 120 has an RGB color space. Each pixel of the graphics signal is expressed by using digital RGB data (24 bits).

The GPU 120 also has a function of not only generating a graphics signal for formation of a graphics screen image but also outputting alpha data corresponding to the generated graphics data to the outside.

Specifically, the GPU 120 outputs a generated graphics signal as a digital RGB video signal to the outside, and also outputs alpha data corresponding to the generated graphics signal. The alpha data is a coefficient (eight bits) indicative of clarity (or opacity) of each pixel of a generated graphics signal. The GPU 120 outputs graphics output data with alpha data (RGBA data consisting of 32 bits) formed of a graphics signal (a digital RGB video signal consisting of 24 bits) and alpha data (eight bits) in accordance with each pixel. The graphics output data with alpha data (the RGBA data consisting of 32 bits) is supplied to the blend processing section 30 through a dedicated graphics bus 20. The graphics bus 20 is a transmission line which connects the GPU 120 with the blend processing section 30.

As described above, in this HD DVD player, the graphics output data with alpha data is directly transferred to the blend processing section 30 from the GPU 120 through the graphics bus 20. As a result, the alpha data does not have to be transferred to the blend processing section 30 from the VRAM 131 through a PCI bus 21 or the like, thus avoiding an increase in a traffic of the PCI bus 21 due to transfer of the alpha data.

If the alpha data is transferred to the blend processing section 30 from the VRAM 131 through the PCI bus 21 or the like, a graphics signal output from the GPU 120 and the alpha data transferred through the PCI bus 21 must be synchronized with each other in the blend processing section 30, whereby a structure of the blend processing section 30 becomes complicated. In this HD DVD player, the GPU 120 synchronizes the graphics signal and the alpha data with each other in accordance with each pixel and outputs an obtained result. Therefore, synchronization of the graphics signal and the alpha data can be readily realized.

The south bridge 14 controls each device in the PCI bus 21. Further, the south bridge 14 includes an IDE (integrated drive electronics) controller which controls the HD DVD drive 18. Furthermore, the south bridge 14 also has a function of controlling the non-volatile memory 15 and the USB controller 17. The USB controller 17 controls a mouse device 171. A user can operate the mouse device 171 to select a menu, for example. Of course, a remote control unit or the like can be used in place of the mouse device 171.

The HD DVD drive 18 is a drive unit which drives a storage media such as an HD DVD media in which audio video (AV) contents corresponding to the HD DVD standard are stored.

The video controller 22 is connected with the PCI bus 21. This video controller 22 is an LSI which executes an interface with the video decoder 25. A stream of main video data separated from an HD DVD stream by software is supplied to the video decoder 25 via the PCI bus 21 and the video controller 22. Moreover, decoding control information output from the CPU 11 is also fed to the video decoder 25 through the PCI bus 21 and the video controller 22.

The video decoder 25 is a decoder corresponding to an H.264/AVC standard, and decodes main video data based on the HD standard to generate a digital YUV video signal which is used to form a video screen image having a resolution of, e.g., 1920×1080 pixels. This digital YUV video signal is transmitted to the blend processing section 30.

The blend processing section 30 is coupled with each of the GPU 120 and the video decoder 25, an executes blend processing of superimposing graphics output data output from the GPU 120 and main video data decoded by the video decoder 25. In this blend processing, blend processing (alpha blending processing) of superimposing a digital RGB video signal constituting graphics data and a digital YUV video signal constituting main video data in a pixel unit is executed based on alpha data output together with graphics data (RGB) from the GPU 120. In this case, the main video data is used as a lower screen image, and the graphics data is used as an upper screen image superimposed on the main video data.

Output image data obtained by the blend processing is supplied to each of the video encoder 40 and the AV interface (HDMI-TX) 41 as, e.g., a digital YUV video signal. The video encoder 40 converts output image data (a digital YUV video signal) obtained by blend processing into a component video signal or an S-video signal, and outputs the converted signal to an external display device (a monitor) such as a TV receiver. The AV interface (HDMI-TX) 41 outputs a digital signal group including the digital YUV video signal and a digital audio signal to an external HDMI device.

The audio controller 23 is connected with the PCI bus 21. The audio controller 23 is an LSI which executes an interface with respect to each of the main audio decoder 31 and the sub audio decoder 32. A stream of main audio data separated from an HD DVD stream by software is transmitted to the main audio decoder 31 via the PCI bus 21 and the audio controller 23. Furthermore, a stream of sub audio data separated from an HD DVD stream by software is fed to the sub audio decoder 32 through the PCI bus 21 and the audio controller 23. Decoding control information output from the CPU 11 is also supplied to each of the main audio decoder 31 and the sub audio decoder 32 through the video controller 22.

The main audio decoder 31 decodes main audio data to generate a digital audio signal in an I2S (inter-IC sound) format. This digital audio signal is supplied to the audio mixer 33. main audio data is compressed and encoded by using arbitrary one of a plurality of types of predetermined compression and encoding modes (i.e., a plurality of types of audio codecs). Therefore, the main audio decoder 31 has a decoding function corresponding to each of the plurality of types of compression and encoding modes. That is, the main audio decoder 31 decodes main audio data compressed and encoded by arbitrary one of the plurality of types of compression and encoding modes to generate a digital audio signal. The main audio decoder 31 is informed of a type of the compression and encoding mode corresponding to main audio data through decoding control information from the CPU 11.

The sub audio decoder 32 decodes sub audio data to generate a digital audio signal in the I2S (inter-IC sound) format. This digital audio signal is transmitted to the audio mixer 33. Sub audio data is also compressed and encoded by using arbitrary one of the plurality of types of predetermined compression and encoding modes (i.e., the plurality of types of audio codecs). Therefore, the sub audio decoder 32 also has a decoding function corresponding to each of the plurality of types compression and encoding modes. That is, the sub audio decoder 32 decodes sub audio data compressed and encoded by using arbitrary one of the plurality of types of compression and encoding modes to generate a digital audio signal. The sub audio decoder 32 is informed of a type of a compression and encoding mode corresponding to sub audio data through decoding control information from the CPU 11.

The audio mixer 33 executes mixing processing of mixing main audio data decoded by the main audio decoder 31 with sub audio data decoded by the sub audio decoder 32 to generate a digital audio output signal. This digital audio output signal is supplied to the AV interface (HDMI-TX) 41, and converted into an analog output signal which is then output to the outside.

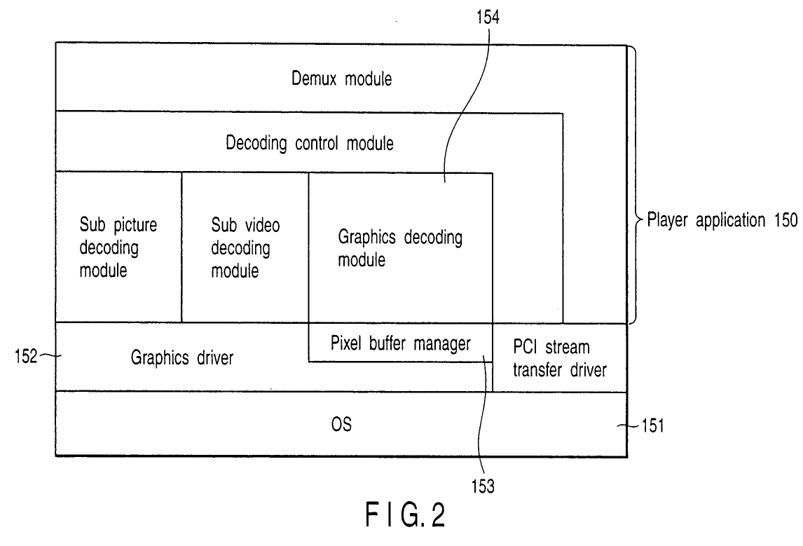

A functional structure of the player application 150 which is executed by the CPU 11 will now be described with reference to FIG. 2.

The player application 150 includes a demultiplexing (demux) module, a decoding control module, a sub-picture decoding module, a sub video decoding module, a graphics decoding module and others.

The demux module is software which executes demultiplexing processing of separating main video data, main audio data, sub-picture data, sub video data and sub audio data from a stream read from the HD DVD drive 18. The decoding control module is software which controls decoding processing with respect to each of main video data, main audio data, sub-picture data, sub video data, sub audio data and graphics data based on navigation data.

The sub-picture decoding module decodes sub-picture data. The sub video decoding module decodes sub video data. The graphics decoding module decodes graphics data (advanced elements).

A graphics driver is software which controls the GPU 120. Decoded sub-picture data, decoded sub video data and decoded graphics data are supplied to the GPU 120 via the graphics driver. Additionally, the graphics driver issues various kinds of draw commands to the GPU 120.

A PCI stream transfer driver is software which transfers a stream through the PCI bus 21. Main video data, main audio data and sub audio data are respectively transferred to the video decoder 25, the main audio decoder 31 and the sub audio decoder 32 via the PCI bus 21 by the PCI stream transfer driver.

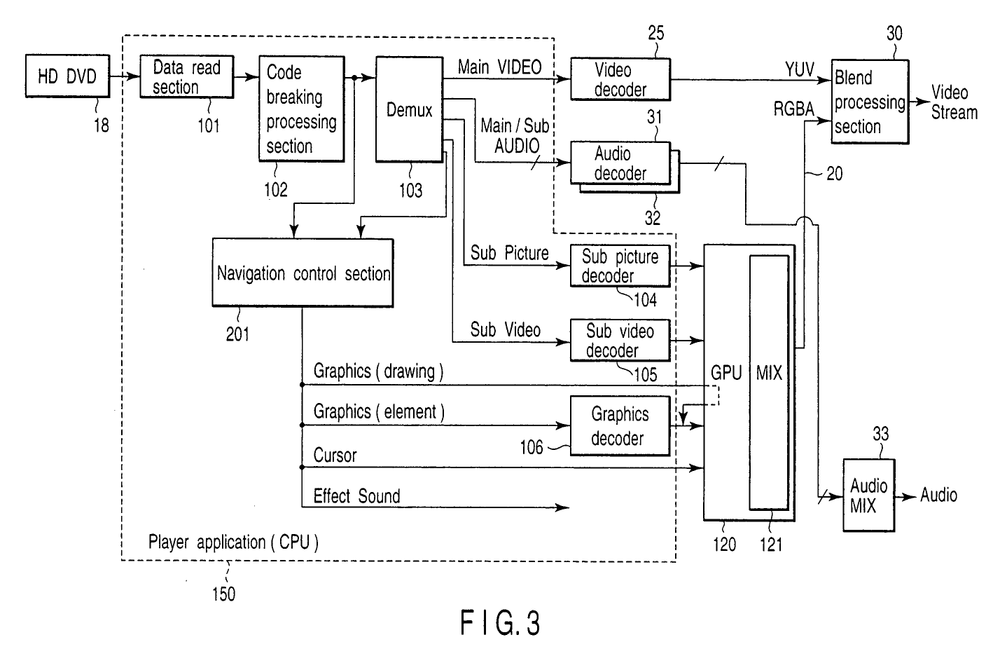

A functional structure of a software decoder realized by the player application 150 executed by the CPU 11 will now be described with reference to FIG. 3.

The software decoder is, as shown in the drawing, provided with a data read section 101, a code breaking processing section 102, a demultiplexing (demux) section 103, a sub-picture decoder 104, a sub video decoder 105, a graphics decoder 106, a navigation control section 201 and others.

Contents (main video data, sub video data, sub-picture data, main audio data, sub audio data, graphics data and navigation data) stored in the HD DVD media of the HD DVD drive 18 are read from the HD DVD drive 18 by the data read section 101. The main video data, the sub video data, the sub-picture data, the main audio data, the sub audio data, the graphics data and the navigation data are respectively encoded. The main video data, the sub video data, the sub-picture data, the main audio data and the sub audio data are multiplexed in an HD DVD stream. The main video data, the sub video data, the sub-picture data, the main audio data, the sub audio data, the graphics data and the navigation data read from an HD DVD media by the data read section 101 are respectively input to the contents code breaking processing section 102. The code breaking processing section 102 executes processing of breaking codes of each data. The navigation data whose code is broken is transmitted to the navigation control section 201. Further, the HD DVD stream whose code is broken is supplied to the demultiplexing section 103.

The navigation control section 201 analyzes a script (XML) included in navigation data to control reproduction of graphics data (advanced elements). The graphics data is supplied to the graphics decoder 106. The graphics decoder 106 is constituted of the graphics decoding module of the player application 150, and decodes graphics data.

Furthermore, the navigation control section 201 also executes processing of moving a cursor in accordance with an operation of the mouse device 171 by a user, processing of responding to a menu selection to reproduce sound effects, and others. Drawing an image by the drawing function is realized by acquiring a mouse device 171 operation from a user by the navigation control section 201, generating graphics data of a picture including a trajectory, i.e., a trajectory of a cursor in the GPU 120 and then re-inputting to the GPU 120 this data as graphics data equivalent to graphics data based on navigation data decoded by the graphics decoder 106.

This demux 103 is realized by the demux module of the player application 150. The demux 103 separates main video data, main audio data, sub audio data, sub-picture data, sub video data and others from an HD DVD stream.

The main video data is supplied to the video decoder 25 via the PCI bus 21. The main video data is decoded by the video decoder 25. The decoded main video data has a resolution of, e.g., 1920×1080 pixels based on the HD standard, and is transmitted to the blend processing section 30 as a digital YUV video signal.

The main audio data is supplied to the main audio decoder 31 via the PCI bus 21. The main audio data is decoded by the main audio decoder 31. The decoded main audio data is supplied to the audio mixer 33 as a digital audio signal having the I2S format.

The sub audio data is fed to the sub audio decoder 32 through the PCI bus 21. The sub audio data is decoded by the sub audio decoder 32. The decoded sub audio data is supplied to the audio mixer 33 as a digital audio signal having the I2S format.

The sub-picture data and the sub video data are respectively transmitted to the sub-picture decoder 104 and the sub video decoder 105. These sub-picture decoder 104 and sub video decoder 105 decode the sub-picture data and the sub video data, respectively. These sub-picture decoder 104 an the sub video decoder 105 are respectively realized by the sub-picture decoding module and the sub video decoding module of the player application 150.

The sub-picture data, the sub video data and the graphic data respectively decoded by the sub-picture decoder 104, the sub video decoder 105 and the graphic decoder 106 are written in the VRAM 131 by the CPU 11. Further, cursor data corresponding to a cursor image is also written in the VRAM 131 by the CPU 11. Each of the sub-picture data, the sub video data, the graphics data and the cursor data includes RGB data and alpha data (A) in accordance with each pixel.

The GPU 120 generates graphics output data forming a graphics screen image of, e.g., 1920×1080 pixels from the sub video data, the graphics data, the sub-picture data and the cursor data written in the VRAM 131 by the CPU 11. In this case, the sub video data, the graphics data, the sub-picture data and the cursor data are superimposed in accordance with each pixel by alpha blending processing executed by a mixer (MIX) section 121 of the GPU 120.

This alpha blending processing uses alpha data corresponding to each of the sub video data, the graphics data, the sub-picture data and the cursor data written in the VRAM 131. That is, each of the sub video data, the graphics data, the sub-picture data and the cursor data written in the VRAM 131 is formed of image data and alpha data. The mixer (MIX) section 121 executes blend processing based on alpha data corresponding to each of the sub video data, the graphics data, the sub-picture data and the cursor data and positional information of each of the sub video data, the graphics data, the sub-picture data and the cursor data specified by the CPU 11 to generate a graphics screen image in which the sub video data, the graphics data, the sub-picture data and the cursor data are superimposed on a background image of, e.g., 1920×1080 pixels.

An alpha value corresponding to each pixel of the background image is a value indicating that this pixel is transparent, i.e., 0. In regard to a region in which respective sets of image data are superimposed in the graphics screen image, new alpha data corresponding to this region is calculated by the mixer (MIX) section 121.

In this manner, the GPU 120 generates graphics output data (RGB) forming a graphics screen image of 1920×1080 pixels and alpha data corresponding to this graphics data from the sub video data, the graphics data, the sub-picture data and the cursor data. It is to be noted that, in regard to a scene in which one of images corresponding to the sub video data, the graphics data, the sub-picture data and the cursor data is displayed, graphics data corresponding to a graphics screen image in which this image (e.g., 720×480) alone is arranged on a background image of 1920×1080 pixels and alpha data corresponding to this graphics data are generated.

The graphics data (RGB) and the alpha data generated by the GPU 120 are supplied to the blend processing section 30 as RGBA data via the graphics bus 20.

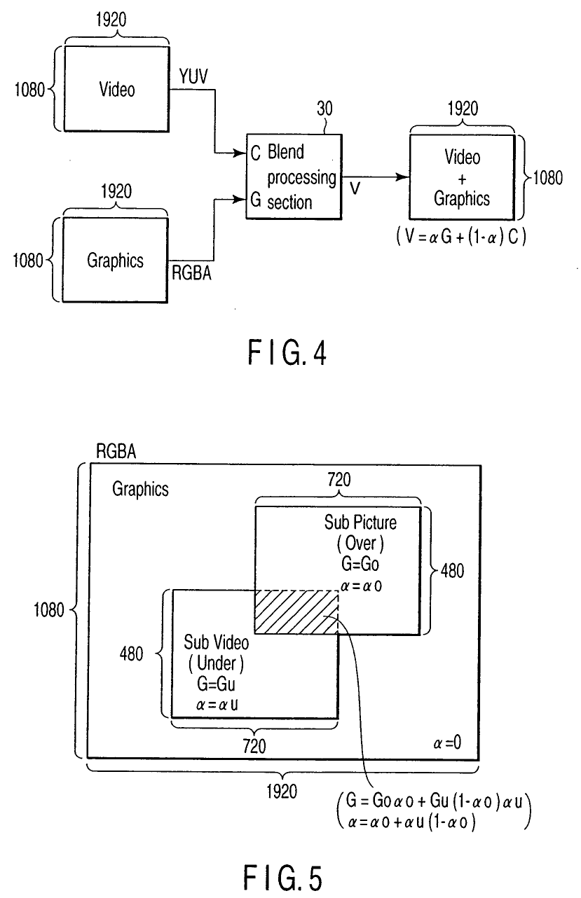

Blend processing (alpha blending processing) executed by the blend processing section 30 will now be described with reference to FIG. 4.

The alpha blending processing is blend processing of superimposing graphics data and main video data in a pixel unit based on alpha data (A) attached to the graphics data (RGB). In this case, the graphics data (RGB) is used as an over-surface and superimposed on Video data. A resolution of the graphics data output from the GPU 120 is the same as that of the main video data output from the video decoder 25.

It is assumed that main video data (Video) having a resolution of 1920×1080 pixels is input to the blend processing section 30 as image data C and graphics data having a resolution of 1920×1080 pixels is input to the blend processing section 30 as image data G. The blend processing section 30 executes an arithmetic operation of superimposing the image data G on the image data C in a pixel unit based on alpha data (A) having a resolution of 1920×1080 pixels. This arithmetic operation is executed by the following expression (1):

V=α×G+(1−α)C (1)

Here, V is a color of each pixel in output image data obtained by the alpha blending processing, and α is an alpha value corresponding to each pixel in the graphics data G.

Blend processing (alpha blending processing) executed by the MIX section 121 of the GPU 120 will now be described with reference to FIG. 5.

Here, it is assumed that graphics data having a resolution of 1920×1080 pixels is generated from sub-picture data and sub video data written in the VRAM 131. Each of the sub-picture data and the sub video data has a resolution of, e.g., 720×480 pixels. In this case, alpha data having a resolution of, e.g., 720×480 pixels is also associated with each of the sub-picture data and the sub video data.

For example, an image corresponding to the sub-picture data is used as an over-surface and an image corresponding to the sub video data is used as an under-surface.

A color of each pixel in a region where an image corresponding to the sub-picture data and an image corresponding to the sub video data are superimposed on each other is obtained by the following expression (2):

G=Go×αo+Gu(1−αo)αu (2)

Here, G is a color of each pixel in the region where the images are superimposed, Go is a color of each pixel in the sub-picture data used as the over-surface, αo is an alpha value of each pixel in the sub-picture data used as the over-surface, and Gu is a color of each pixel of the sub video data used as the under-surface.

Furthermore, an alpha value of each pixel in a region where an image corresponding to the sub-picture data and an image corresponding to sub video data are superimposed on each other is obtained by the following expression (3):

α=αo+αu×(1−αo) (3)

Here, α is an alpha value of each pixel in the region where the images are superimposed, and αu is an alpha value of each pixel in the sub video data used as the under-surface.

In this manner, the MIX section 121 of the GPU 120 utilizes the alpha data used as the over-surface of the alpha data corresponding to the sub-picture data and the alpha data corresponding to sub video data to superimpose the sub-picture data and the sub video data, thereby generating graphics data forming a screen image of 1920×1080 pixels. Moreover, the MIX section 121 of the GPU 120 calculates an alpha value of each pixel in graphics data forming a screen image of 1920×1080 pixels from the alpha data corresponding to the sub-picture data and the alpha data corresponding to the sub video data.

Specifically, the MIX section 121 of the GPU 120 executes blend processing of superimposing a surface of 1920×1080 pixels (a color of all pixels=black, an alpha value of all pixels=0), a surface of the sub video data having 720×480 pixels and a surface of the sub-picture data having 720×480 pixels to calculate graphics data forming a screen image of 1920×1080 pixels and alpha data having 1920×1080 pixels. The surface of the 1920×1080 pixels is used as the lowest surface, the surface of the sub video data is used as the second lowest surface, and the surface of the sub-picture data is used as the highest surface.

In the screen image having 1920×1080 pixels, a color of each pixel in a region where both the sub-picture data and the sub video data do not exist is black. Additionally, a color of each pixel in a region where the sub-picture data alone exists is the same as an original color of each corresponding pixel in the sub-picture data. Likewise, a color of each pixel in a region where the sub video data alone exists is the same as an original color of each corresponding pixel in the sub video data.

Further, in the screen image having 1920×1080 pixels, an alpha value corresponding to each pixel in a region where both the sub-picture data and the sub video data do not exist is zero. An alpha value of each pixel in a region where the sub-picture data alone exists is the same as an original alpha value of each corresponding pixel in the sub-picture data. Similarly, an alpha value of each pixel in a region where the sub video data alone exists is the same as an original alpha value of each corresponding pixel in the sub video data.

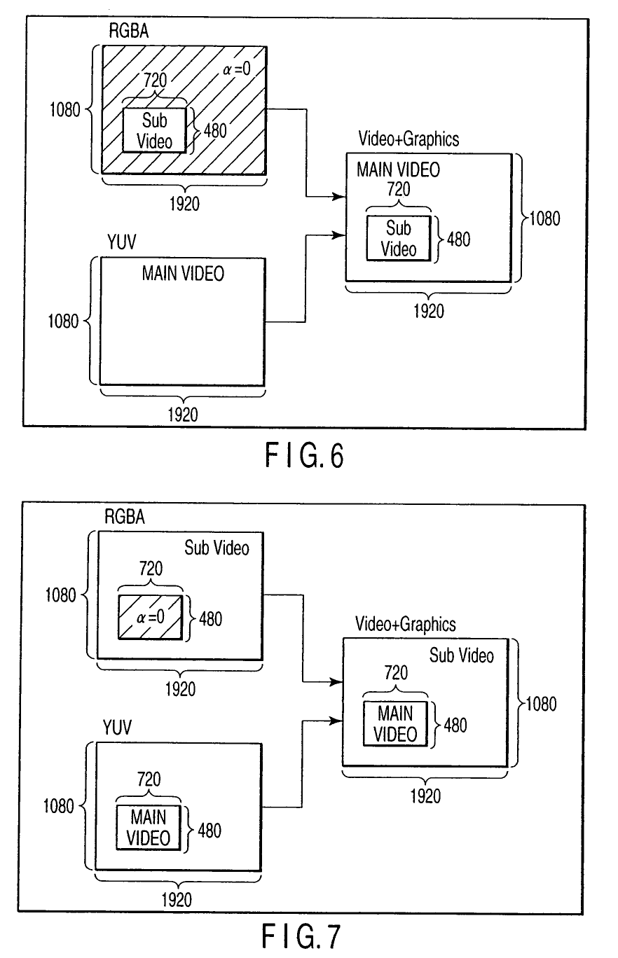

FIG. 6 shows how sub video data having 720×480 pixels is superimposed on main video data having 1920×1080 pixels and displayed.

In FIG. 6, graphics data is generated by blend processing of superimposing a surface of 1920×1080 pixels (a color of all pixels=black, an alpha value of all pixels=0) and a surface of sub video data having 720×480 pixels in accordance with each pixel.

As described above, output image data (Video+graphics) output to the display device is generated by blending graphics data and Main video data.

Of the graphics data having 1920×1080 pixels, an alpha value of each pixel in a region where the sub video data having 720×480 pixels does not exist is zero. Therefore, the region where the sub video data having 720×480 pixels becomes transparent, and hence the main video data is displayed in this region with 100% opacity.

Each pixel in the sub video data having 720×480 pixels is displayed on the main video data with transparency specified by alpha data corresponding to the sub video data. For example, a pixel in the sub video data having an alpha value=1 is displayed with 100% opacity, and a pixel in the main video data corresponding to a position of this pixel is not displayed.

Furthermore, as shown in FIG. 7, the main video data reduced to a resolution of 720×480 pixels can be also displayed in a part of the region of the sub video data expanded to a resolution of 1920×1080 pixels.

A display conformation of FIG. 7 is realized by using a scaling function of the GPU 120 and a scaling function of the video decoder 25.

Specifically, the GPU 120 executes scaling processing of gradually increasing a resolution (a screen size) of the sub video data until the resolution of the sub video data reaches 1920×1080 pixels in accordance with an instruction from the CPU 11. This scaling processing is carried out by using pixel interpolation. As the resolution of the sub video data is increased, a region where the sub video data having 720×480 pixels does not exist (a region with an alpha value=0) in the graphics data having 1920×1080 pixels is gradually reduced. As a result, a size of the sub video data displayed while being superimposed on the main video data is gradually increased and, contrary, the region with the alpha value=0 is gradually reduced. When the resolution (an image size) of the sub video data has reached 1920×1080 pixels, the GPU 120 executes blend processing of superimposing a surface of 720×480 pixels (a color of all pixels=black, an alpha value of all pixels=0) on the sub video data having 1920×1080 pixels in accordance with each pixel to arrange the region of 720×480 pixels with the alpha value=0 on the sub video data having 1920×1080 pixels.

On the other hand, the video decoder 25 executes scaling processing of reducing a resolution of the main video data to 720×480 pixels in accordance with an instruction from the CPU 11.

The main video data reduced to 720×480 pixels is displayed in a region of 720×480 pixels with an alpha value=0 which is arranged on the sub video data having 1920×1080 pixels. That is, the alpha data output from the GPU 120 can be also used as a mask which restricts a region in which the main video data is displayed.

Since the alpha data output from the GPU 120 can be freely controlled by software in this manner, the graphics data can be effectively superimposed on the main video data and displayed, thereby readily realizing expression of a picture having high interactivity. Furthermore, since the alpha data is automatically transferred together with the graphics data from the GPU 120 to the blend processing section 30, software does not have to have a consciousness about transfer of the alpha data to the blend processing section 30.

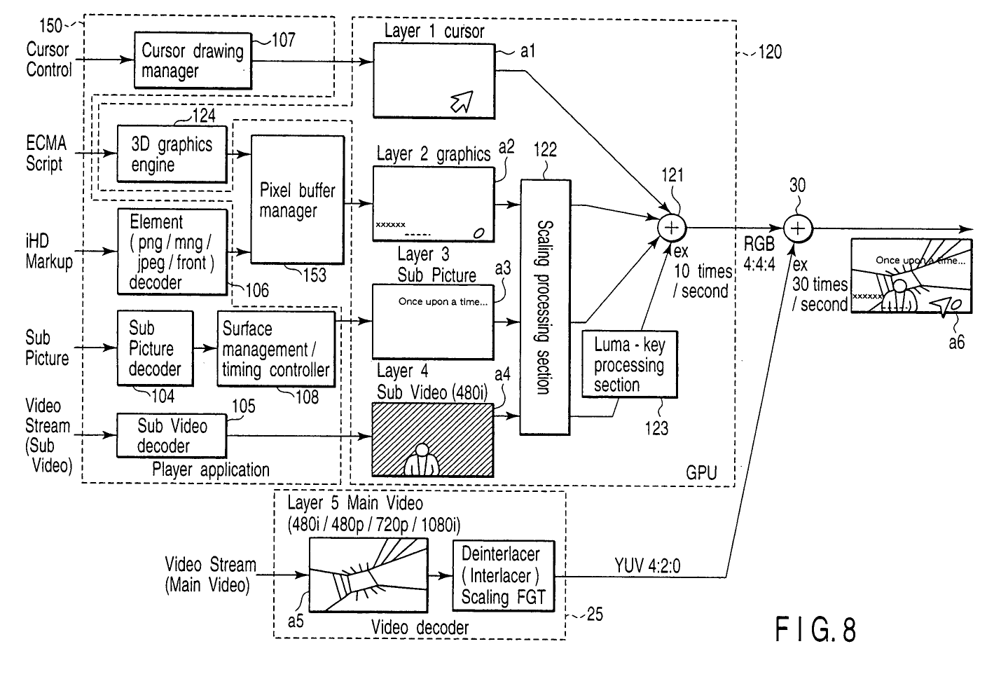

FIG. 8 is a conceptual view showing a procedure of superimposing each of a plurality of sets of image data in AV contents based on the HD standard reproduced by this HD DVD player by the GPU 120 and the blend processing section 30 which operate as described above.

In the HD standard, five layers, i.e., a layer 1 to a layer 5 are defined, and the above-mentioned cursor, graphics, sub-picture, sub video and Main video are respectively allocated to each layer. Moreover, as shown in FIG. 8, this HDD DVD player executes superimposition of four images a1 to a4 of the layer 1 to the layer 4 among the layer 1 to the layer 5 as pre-processing in the mixer section 121 of the GPU 120, and executes superimposition of an output image from this GPU 120 and an image a5 of the layer 5 as post-processing in the blend processing section 30, thus creating a target image a6.

When superimposition of the five sets of image data of the layers 1 to 5 defined based on the HD standard is divided into two stages in this manner, this HD DVD player appropriately distributes a load. Additionally, main video of the layer 5 is a high-definition picture, and each frame must be updated at a rate of 30 frames/second. Therefore, superimposition must be carried out for 30 times/second in the blend processing section 30 which processes this main video. On the other hand, since a high image quality like that of Main video is not required in cursor, graphics, sub-picture and sub video of the layers 1 to 4, and hence executing superimposition for, e.g., 10 times/second in the mixer section 121 in the GPU 120 can suffice. If superimposition of cursor, graphics, sub-picture, sub video of the layers 1 to 4 is executed with main video of the layer 5 in the blend processing section 30, superimposition is executed for 30 times/second with respect to each of the layers 1 to 4, namely, execution of 20 times/second is beyond necessity. That is, secondly, this HD DVD player appropriately promotes an efficiency.

Although cursor, graphics, sub-picture and sub video of the layers 1 to 4 are supplied from the player application 150 to the GPU 120, the player application 150 has, as shown in FIG. 8, a cursor drawing manager 107 and a surface management/timing controller 108 as well as the sub-picture decoder 104, the sub video decoder 105 and the graphics decoder (an element decoder) 106 mentioned above in order to supply each image data to this GPU 120.

The cursor drawing manager 107 is realized as one function of the navigation control section 201, and executes cursor drawing control to move a cursor in response to an operation of the mouse device 171 by a user. On the other hand, the surface management/timing controller 108 executes timing control to appropriately display an image of sub-picture data decoded by the sub-picture decoder 104.

It is to be noted that cursor Control in the drawing denotes control data for movement of the cursor issued by the USB controller 17 in accordance with an operation of the mouse device 171. ECMA Script designates a script in which drawing API instructing drawing of a point, a line, a graphic symbol or the like is written. iHD Markup is text data written in a markup language in order to display various Advanced Elements on a timely basis.

Further, the GPU 120 has a scaling processing section 122, a luma-key processing section 123 and a 3D graphics engine 124 as well as the mixer section 121.

The scaling processing section 122 executes the scaling processing mentioned in conjunction with FIG. 7. The luma-key processing section 123 executes luma-key processing of setting an alpha value of a pixel whose luminance value is not greater than a threshold value to zero to thereby removes a background (black) in an image. The 3D graphics engine 124 carries out generation processing of graphics data including production of an image for the drawing function (a picture including a trajectory of a cursor).

As shown in FIG. 8, this HD DVD player performs scaling processing with respect to images a2 to a4 of the layers 2 to 4, and further carries out luma-key processing with respect to the image a4 of the layer 4. Furthermore, in this HD DVD player, each of these scaling processing and luma-key processing is not solely executed by the GPU 120, but it is executed simultaneously with blend processing when performing this blend processing (by the mixer section 121). In terms of the player application 150, the scaling processing or the luma-key processing is requested simultaneously with the blend processing. If the scaling processing or the luma-key processing is solely executed by the GPU 120, an intermediate buffer which temporarily stores an image after the scaling processing or an image after the luma-key processing is required, and data must be transferred between this intermediate buffer and the GPU 120. On the other hand, in this HD DVD player which performs so-called pipeline processing by which the scaling processing section 122, the luma-key processing section 123 and the mixer section 121 are activated in cooperation with each other, i.e., an output from the scaling processing section 122 is input to the luma-key processing section 123 as needed and an output from the luma-key processing section 123 is input to the mixer section 121 as needed in the GPU 120, the intermediate buffer is not required, and transfer of data between the intermediate buffer and the GPU 120 does not occur. That is, this HD DVD player also achieves appropriate promotion of an efficiency in this point.

It is to be noted that a Pixel buffer manager 153 shown in FIG. 8 is middleware which executes management of allocation of a Pixel buffer used as a work region for drawing a picture by a mouse operation using the 3D graphics engine 124 or drawing an object of, e.g., an operation guidance by the element decoder 106. In order to further optimize management of allocation by a driver which is prepared to use the Pixel buffer as hardware in software, the Pixel buffer manager 153 is interposed between this driver and a host system using this Pixel buffer.

As described above, in this HD DVD player, appropriate load distribution and promotion of an efficiency are achieved by dividing superimposition of five sets of image data of the layers 1 to 5 defined in the HD standard into two stages, and further promotion of an efficiency is attained by executing the scaling processing or the luma-key processing simultaneously with the blend processing.

Sub video data in the various kinds of image data will be described below.

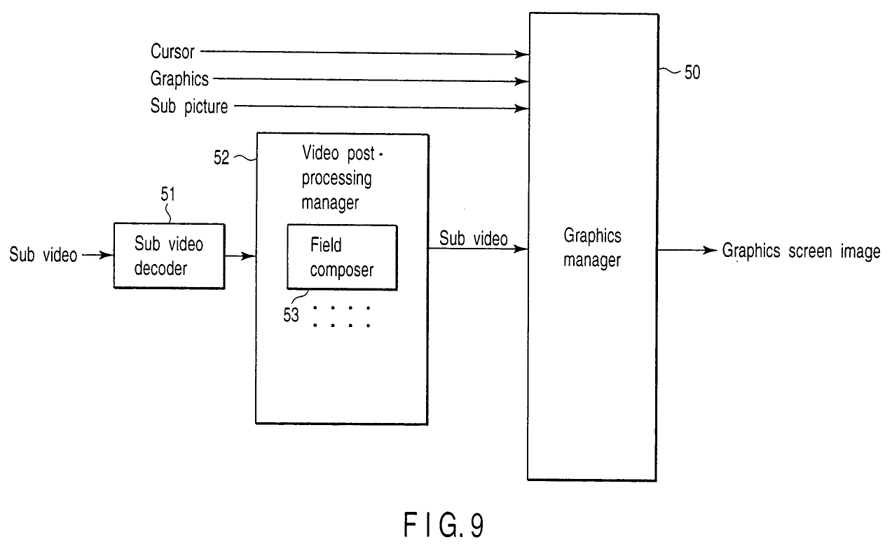

FIG. 9 is a block diagram showing constituent parts concerning control which realizes reproduction of a picture quality comparable to that of a commercial-off-the-shelf device by using a function of the GPU 120.

A graphics manager 50 performs control of executing graphics processing including blend processing with respect to image data of the respective layers such as cursor, graphics, sub-picture or sub video to form a graphics screen image.

A sub video decoder 51 corresponds to the decoder 105 in FIG. 8, and carries out decoding processing with respect to sub video data supplied thereto. A video post-processing manager 52 is provided between the sub video decoder 51 and the graphics manager 50, and executes necessary post-processing to decoded sub video data and then outputs the processed data. A field composer 53 is provided in the video post-processing manager 52, and performs field assembling processing or the like concerning sub video data which should be supplied to later-described frame buffers through the graphics manager 50. Processing realized by this field composer 53 will be described below in detail.

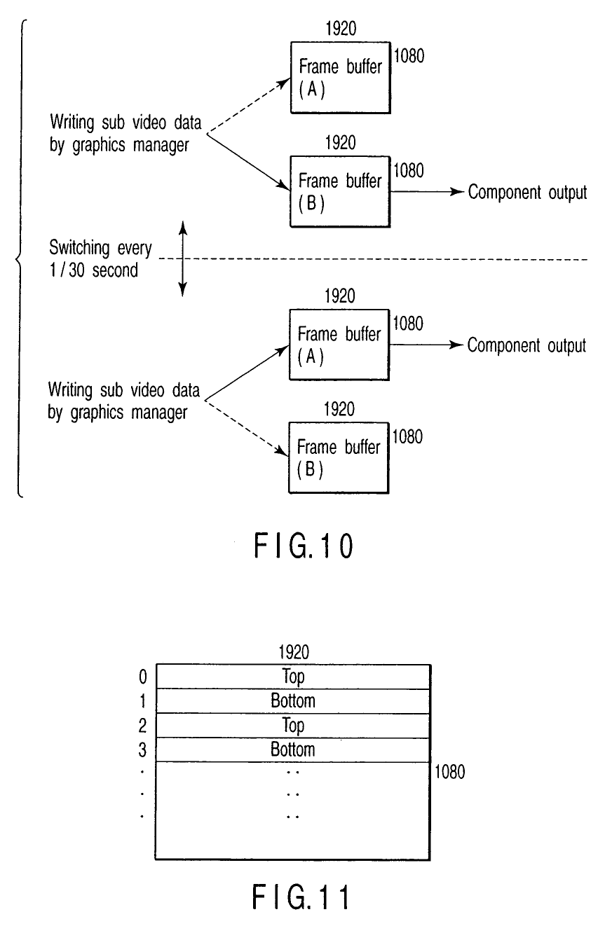

FIG. 10 is a view explaining a double buffer mode using frame buffers.

A frame buffer (A) and a frame buffer (B) constituting a double buffer alternately store and output graphics data generated by the GPU 120, and they are controlled by the graphics manager 50. For example, the graphics manager 50 switches a first state in which writing sub video data in the frame buffer (A) is stopped and writing in the frame buffer (B) is executed and a second state in which writing sub video data in the frame buffer (B) is stopped and writing in the frame buffer (A) is executed every 1/30 second, for example.

FIG. 11 is a view explaining a configuration of data stored in one frame buffer.

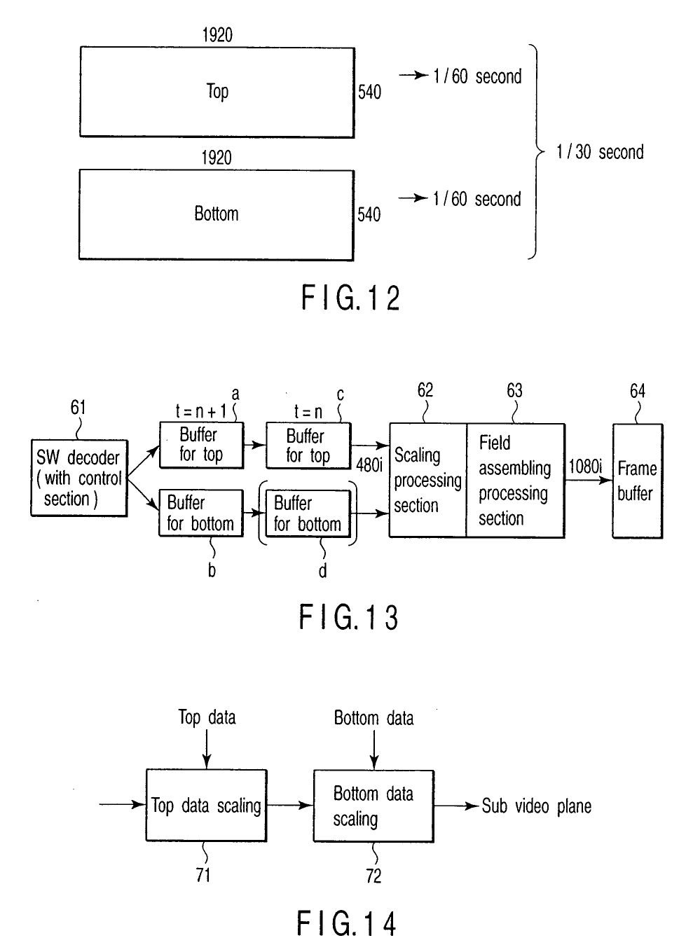

The frame buffer has an image size of 1920×1080 pixels, and can be used to store both graphics data which is suitable for reproduction of a picture in an interlace mode and graphics data suitable for reproduction of a picture in a progressive mode. In order to cope with the interlace mode, data in even-numbered lines depicted in FIG. 11 must be collectively written as data in a top field for the interlace mode as shown in FIG. 12, and data in odd-numbered lines depicted in FIG. 11 must be collectively written as data in a bottom field for the interlace mode as shown in FIG. 12. Performing such data writing as illustrated in FIG. 12 can form a graphics screen image based on the interlace mode. In this case, data in the top field is read in 1/60 second, and data in the bottom field is also read in 1/60 second. As a result, an image corresponding to one frame is generated in 1/30 second.

FIG. 13 is a view explaining processing realized by the field composer.

An S/W decoder 61 is a decoder realized by software, and performs control to alternately store, e.g., data of even-numbered lines and data of odd-numbered lines in supplied picture data based on the progressive mode at a rate of 24 frames/second into a plurality of buffers and control to stop and restart supply of data, thereby generating pulled-down picture data having 30 frames/second.

Buffers a, b, c and d are controlled by the S/W decoder 61 and used to generate pulled-down picture data. It is to be noted that the buffer d is not necessarily required.

A scaling processing section 62 carries out scaling processing of increasing a resolution of picture data generated from the plurality of buffers based on control by the S/W decoder 61 (e.g., processing of increasing from 720×480 pixels to 1920×1080 pixels) as pre-processing of field assembling processing performed by a field assembling processing section 63.

The field assembling processing section 63 performs field assembling processing of graphics data having a resolution appropriate for an image size of the frame buffer 64 based on picture data subjected to scaling processing by the scaling processing section 62. That is, this field assembling processing section 63 forms graphics data appropriate for picture reproduction in the interlace mode.

The frame buffer 64 stores graphics data formed by the field assembling processing section 63. This graphics data has such a data configuration as shown in FIG. 12, and is suitable for picture reproduction in the interlace mode.

FIG. 14 is a view showing an example of an internal configuration of the scaling processing section 62 depicted in FIG. 13.

The scaling processing section 62 has a top data scaling processing section 71 and a bottom data scaling processing section 72. The top data scaling processing section 71 receives data for a top field to carry out scaling processing and supplies data subjected to scaling processing to the bottom data scaling processing section 72 on the next stage. The bottom data scaling processing section 72 receives data for a bottom field to perform scaling processing, combines data subjected to this scaling processing and scaling-processed data for the top field fed from the previous stage, and outputs the combined data as a sub video plane.

FIG. 15 is a view explaining a procedure of controlling the buffers a, b and c by the S/W decoder 61 depicted in FIG. 13.

The S/W decoder 61 controls in such a manner that respective sets of data in the buffer a and the buffer b are supplied to the frame buffer side in generation of a first frame. In generation of a second frame, likewise, control is performed in such a manner that respective sets of data in the buffer a and the buffer b are supplied to the frame buffer side. In generation of a third frame, control is carried out in such a manner that respective sets of data in the buffer c and the buffer b are supplied to the frame buffer side. In generation of a fourth frame, likewise, respective sets of data in the buffer c and the buffer b are supplied to the frame buffer side. The S/W decoder 61 temporarily stops the operation upon completion of the processing of the fourth frame, and then controls in such a manner that respective sets of data in the buffer a and the buffer b are supplied to the frame buffer side in generation of a fifth frame. Thereafter, the same procedure are repeated.

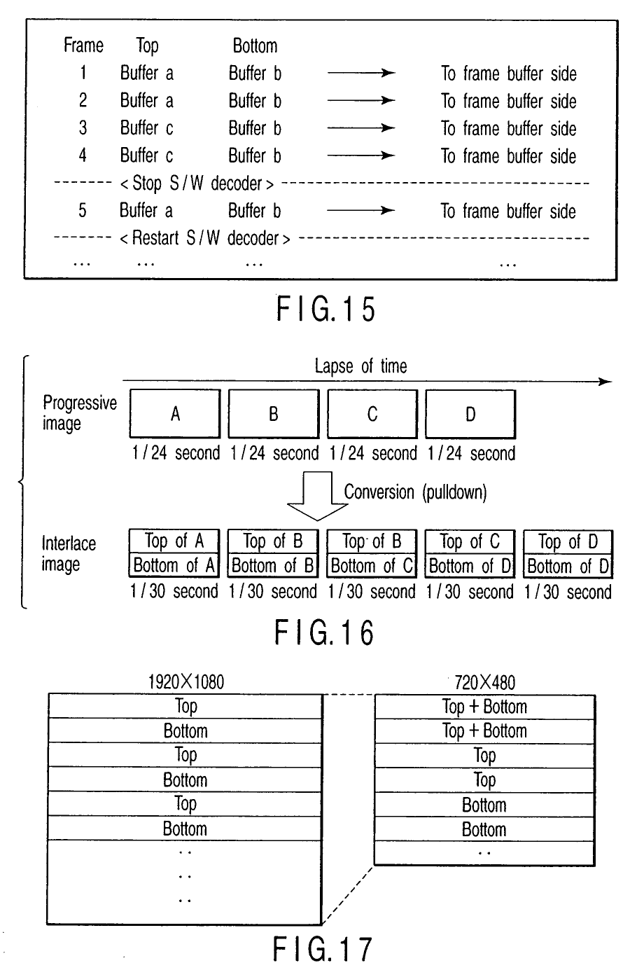

FIG. 16 is a view showing how a progressive image is pulldown-converted into an interlace image by the control depicted in FIG. 15.

For example, it is assumed that progressive images A, B, C and D are sequentially supplied every 1/24 second. In this case, five interlace images are generated every 1/30 second based on these four frames.

The interlace image of the first frame is an image obtained by combining data for the top field of the image A and data for the bottom field of the image A. The interlace image of the second frame is an image obtained by combining data for the top field of the image B with data for the bottom field of the image B. The interlace image of the third frame is an image obtained by combining data for the top field of the image B with data for the bottom field of the image C. The interlace image of the fourth frame is an image obtained by combining data for the top field of the image C with data for the bottom field of the image D. The interlace image of the first frame is an image obtained by combining data for the top field of the image D with data for the bottom field of the image D.

FIG. 17 is a view showing a specific technique in the scaling processing.

In case of executing the scaling processing between data of 920×1080 pixels and data of 720×480 pixels, such data assignment as shown in FIG. 17 is performed, for example. That is, an entire image is formed by appropriately combining conversion processing which forms one field based on data for a top field and bottom data and processing which does not perform such conversion processing, thereby realizing desired scaling processing.

As described above, according to the embodiments, a function such as a GPU can be used to reproduce a picture having a picture quality comparable to that of a commercial-off-the-shelf device based on the interlace mode in the information processing apparatus such as a PC.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a frame buffer to store graphics data;
a control section to perform control to alternately store in a plurality of buffers data of even-numbered lines and data of odd-numbered lines in picture data based on a progressive mode and to perform control to stop and restart supply of data, thereby generating pulled-down picture data; and
a field assembling processing section to execute field assembling processing of graphics data having a resolution appropriate for an image size of the frame buffer based on the picture data generated by the control section.

2. The apparatus according to claim 1, further comprising a scaling processing section to perform scaling processing of increasing a resolution of image data generated by the control section as pre-processing of the field assembling processing by the field assembling processing section.

3. The apparatus according to claim 1, wherein the field assembling processing section forms graphics data appropriate for picture reproduction in an interlace mode.

4. The apparatus according to claim 1, wherein the control section is realized by a decoder of software.

5. The apparatus according to claim 1, wherein the frame buffer stores graphics data appropriate for picture reproduction in the interlace mode.

6. The apparatus according to claim 1, wherein the frame buffer is configured to store both graphics data appropriate for picture reproduction in the interlace mode and graphics data appropriate for picture reproduction in the progressive mode.

7. An information processing method comprising:
performing control to alternately store in a plurality of buffers data of even-numbered lines and data of odd-numbered lines in picture data based on a progressive mode and performing control to stop and restart supply of data, thereby generating pulled-down picture data; and
effecting field assembling processing of graphics data having a resolution appropriate for an image size of a frame buffer configured to store the graphics data based on the generated picture data.

8. The method according to claim 7, further comprising executing scaling processing of increasing a resolution of the generated image data as pre-processing of the field assembling processing.

9. The method according to claim 7, wherein the field assembling processing includes forming graphics data appropriate for picture reproduction in an interlace mode.

10. The information processing method according to claim 7, wherein the control is realized by a decoder of software.
